(19) United States
(12) Patent Application Publication
(10) Pub. No.: US 2013/0257138 A1
(43) Pub. Date: Oct. 3, 2013

(54) MULTI-DIRECTIONAL DRIVING MECHANISM OF A SPHERIC WHEEL

(71) Applicant: Feng-Jung CHANG, Taichung City (TW)

(72) Inventor: Feng-Jung CHANG, Taichung City (TW)

(21) Appl. No.: 13/433,648

(22) Filed: Mar. 29, 2012

(51) Int. Cl. B60B 19/12

(52) U.S. Cl. 301/5.23

(57) ABSTRACT

A multi-directional driving mechanism of a spheric wheel is assembled at a preset position on the surface of an existing spheric wheel, thus driving multi-directional rotation of the spheric wheel. The multi-directional driving mechanism comprises at least two driving wheels assembled at opposite directions of the spheric wheel. An axle is set at the enter of said driving wheel for driving the rotation via a driving gear. One lateral side of the driving wheel is abutted tightly onto the surface of the spheric wheel for frictional driving. Rolling elements are pivoted at interval on the periphery of the driving wheel and the axial direction of said rolling elements runs perpendicular to the axial direction of axle on the driving wheel. The driving wheels assembled at opposite directions could be abutted normally onto the surface of the spheric wheel for driving or sliding without mutual interference.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a spheric wheel, and more particularly to an innovative one which is designed with multi-directional driving control functions.

2. Description of Related Art Including Information Disclosed Under 37 CFR 1.97 and 37 CFR 1.98.

Electric vehicles such as electric four-wheel vehicles, electric lift trucks and electric wheelchairs, are now widely used in everyday life.

Generally, a common electric vehicle moves linearly forwards or backwards. If it is intended for changing the direction, it is required to drive the steering of the wheel body, or if it is intended for parking, the skills for roadside parking shall be required. However, it takes time to park properly if the driver is a novice or unskilled, or if the parking space is limited.

To this end, a wheel structure combining straight and transverse movements has been developed, as illustrated by ROC patent No. M317853: “a wheel structure of electric vehicle with straight and transverse movement functions” wherein the spheric main wheel is retained firmly by a criss-cross holding unit on its periphery. Two perpendicular support legs in the holding unit are provided with first and second starters composed of a pressure cylinder, servo motor and startup wheel. The startup wheel of the first starter is abutted to drive the spheric main wheel for straight rolling, and that of the second starter is abutted to drive the spheric main wheel for transverse rolling.

However, the following shortcomings of the prior art are still observed during actual applications:

The wheel of typical electric vehicle is structurally designed in a way that the startup wheels of the first and second starters are abutted onto the spheric main wheel from different axle directions. When the startup wheel of either the first or the second starter is set to drive the spheric main wheel, the other startup wheel may baffle the rolling of the spheric main wheel due to different axle direction. For this reason, a clutch gear is additionally designed for separate clutch control of the startup wheels of the first and second starters, namely, when the startup wheel of either the first or the second starter is set to drive the spheric main wheel, the other startup wheel is disengaged from the spheric main wheel. Yet, this will increase the difficulty and configuration cost of the drive controller components, making it necessary for further improvement.

Moreover, the startup wheels of the first and second starters are lowered down close to the maximum diameter position of the spheric main wheel (i.e.: the height of the rotation center), thus minimizing the blocking of the startup wheels against the spheric main wheel. However, in such a case, since the starter is set externally at the maximum diameter position of the spheric main wheel, this will increase greatly the maximum external diameter and volume of the holding unit with prejudice to lightweight and compact design of the products.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique design of the present invention wherein the “multi-directional driving mechanism of spheric wheel” mainly comprises a spheric wheel, driving wheels and driving gear, the driving wheels assembled at opposite directions could be abutted normally onto the surface of the spheric wheel for driving or sliding without mutual interference. As compared with the prior art, the present invention could be operated more smoothly without an additional driving controller and clutch gear, so it features simple construction, stronger stability, lower manufacturing cost and floor area with improved applicability and industrial benefits.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the present invention wherein the yokes of the driving wheels are combined with the rolling elements.

FIG. 2 is a top view wherein the present invention is combined with the frame and front wheel set.

FIG. 3 is a lateral view wherein the spheric wheel and driving wheel of the present invention are combined with an electric wheelchair.

FIG. 4 is an actuating status view of the driving wheel of the present invention with the rolling element and spheric wheel.

FIG. 5 is an enlarged lateral view of the driving wheel and spheric wheel of the present invention in actuating status.

FIG. 6 is an enlarged lateral view of the rolling element and spheric wheel of the present invention in actuating status.

FIG. 7 is an enlarged view of the driving wheel of the present invention combined with the driving gear.

FIG. 8 is an exploded perspective view of the spheric wheel of the present invention.

FIG. 9 is a plan sectional view of the internal structure of the spheric wheel of the present invention.

### DETAILED DESCRIPTION OF THE INVENTION

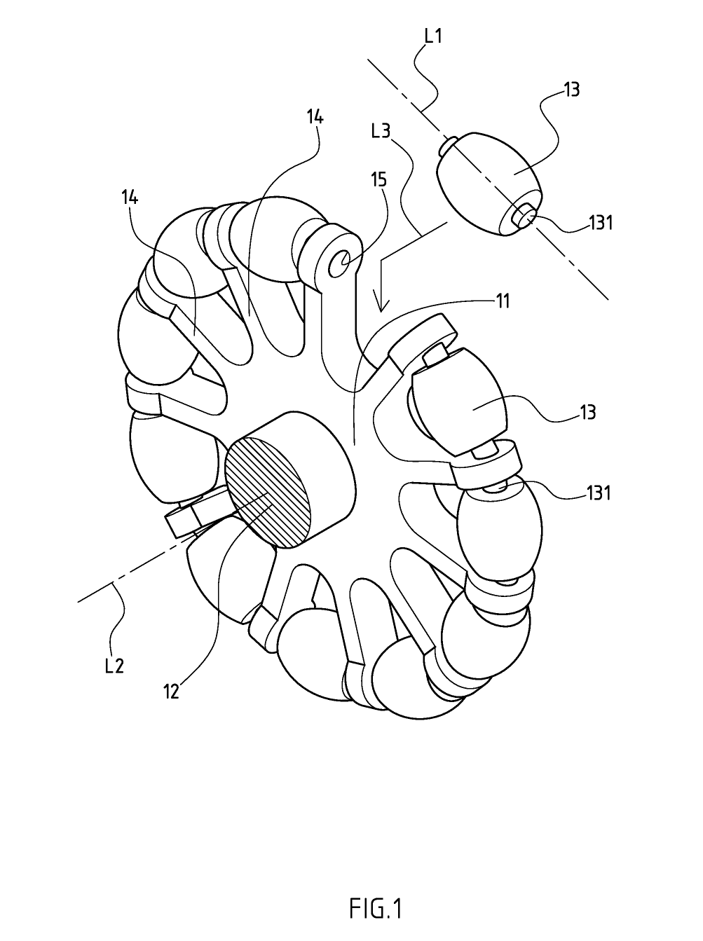

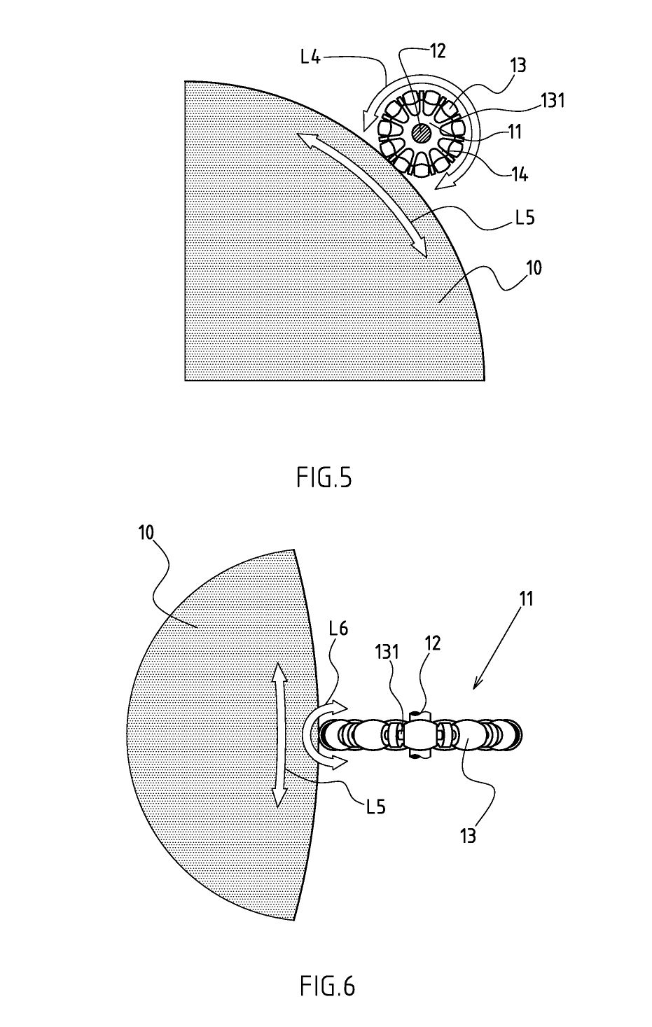

FIGS. 1-9 depict preferred embodiments of the spheric wheel's multi-directional driving mechanism of the present invention, which, however, are provided for only explanatory objective for patent claims.

Referring to FIGS. 1-9, said multi-directional driving mechanism is assembled at a preset position on the surface of existing spheric wheel 10, thus driving multi-directional rotation of the spheric wheel 10. The multi-directional driving mechanism comprises at least two driving wheels 11 assembled at opposite directions of the spheric wheel 10. An axle 12 is set at center of said driving wheel 11 for driving the rotation via a driving gear 30. One lateral side of the driving wheel 11 is abutted tightly onto the surface of the spheric wheel 10 for frictional driving. It is characterized in that rolling elements 13 are pivoted at interval on the periphery of the driving wheel 11. Further, the axial direction of said rolling elements 13 (indicated by L1 in FIG. 1) runs perpendicular to the axial direction of axle 12 on the driving wheel 11 (indicated by L2 in FIG. 1). With this design, when the driving wheel 11 is rotated by taking the axle 12 as its pivot, the spheric wheel 10 could be driven frictionally. When the axial directions of the driving wheel 11 and spheric wheel 10 are different from each other, the rolling elements 13 on the periphery of the driving wheel 11 will be frictionally pushed to rotate by the surface of the spheric wheel 10, so that the driving wheels 11 assembled at opposite directions could be abutted normally onto the surface of the spheric wheel 10 for driving or sliding without mutual interference.

Referring to FIG. 1, yokes 14 are set at interval onto the periphery of the driving wheel 11 in a radial pattern. Axle holes 15 are set at external ends of said yokes 14. Said rolling elements 13 are of a column body with convex surface. Convex shafts 131 are set at two opposite ends of the rolling elements 13 for assembly into the axle holes 15 set at external ends of the yokes 14, so that the rolling elements 13 could be buckled into the axle holes 15 on the yokes 14 by using the convex shafts 131 (indicated by arrow L3).

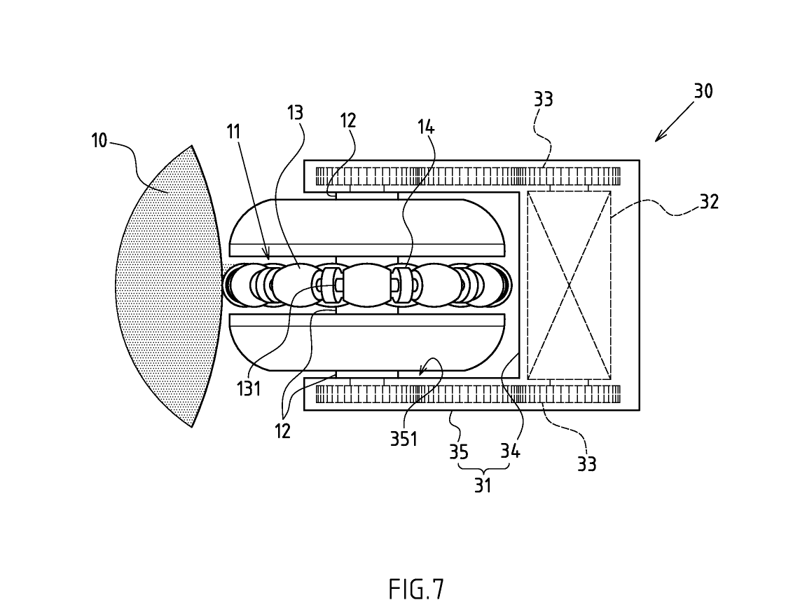

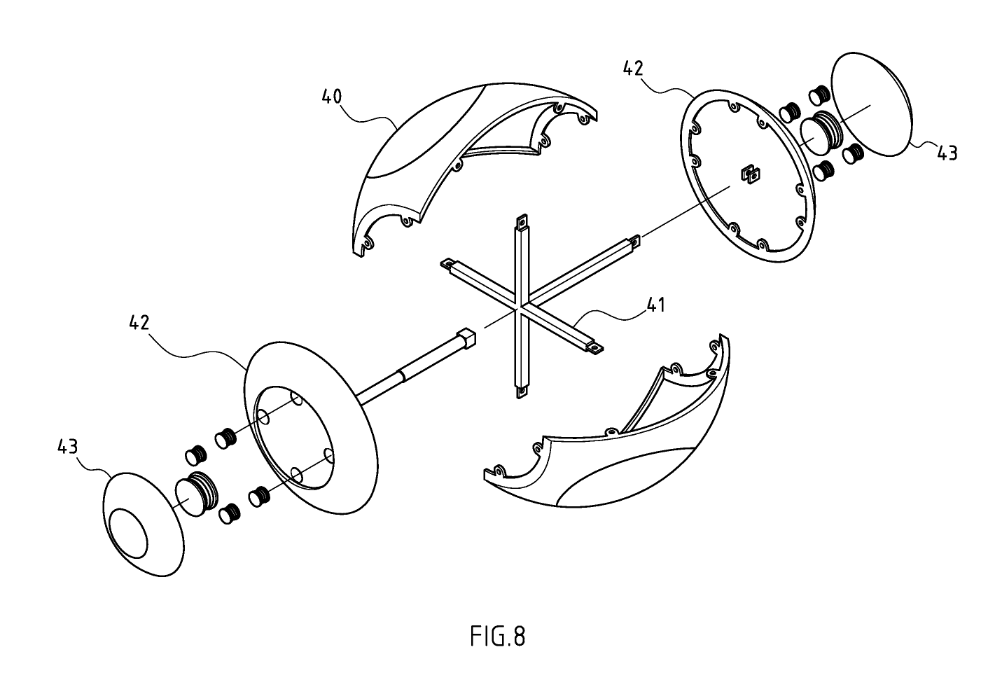

Referring also to FIG. 7, the driving gear 30 for driving the rotation of the driving wheel 11 comprises of a [symbol] -shaped frame 31, a driving motor 32 and changing gear sets 33. Said [symbol] -shaped frame 31 comprises of a main frame 34 and two side frames 35 set laterally at interval onto the main frame 34. A holding space 351 is defined between two side frames 35 to accommodate the driving wheel 11. The driving motor 32 is accommodated into the main frame 34, while the changing gear sets 33 are separately set into two side frames 35, so as to link the driving motor 32 and the axle 12 of the driving wheel 11, enabling the driving gear 30 to drive the clockwise and counter-clockwise rotation of the driving wheel 11 for driving the spheric wheel 10.

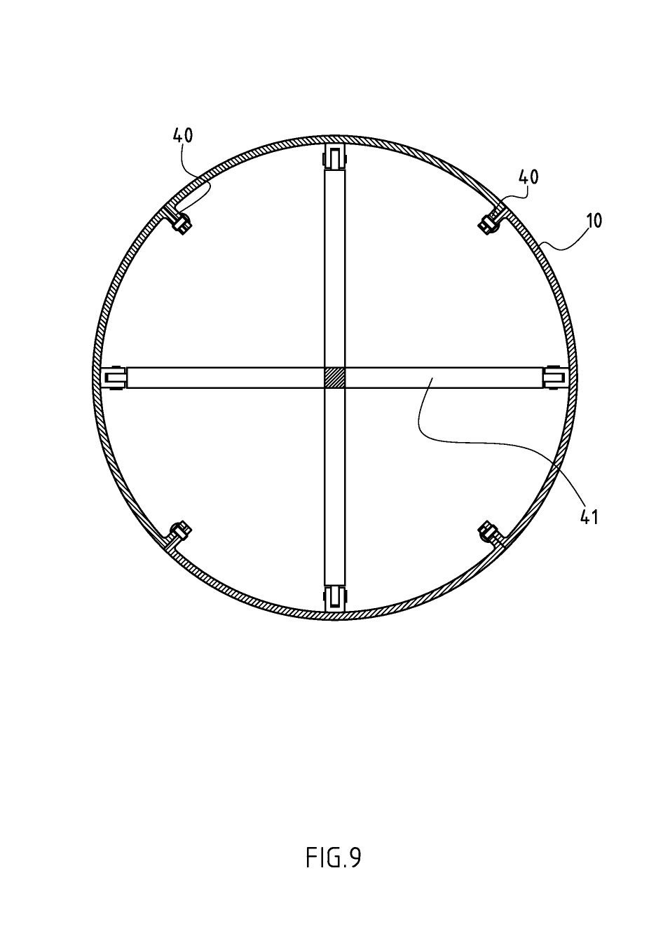

Referring also to FIGS. 8 and 9, the spheric wheel 10 is of a hollow round ball, which is assembled securely by several arched shell plates 40. A criss-cross skeleton 41 is combined internally to support the arched shell plates 40. The arched shell plates 40 and the criss-cross skeleton 41 can be fixed to form a complete round ball using two end plates 42 and two corresponding end covers 43.

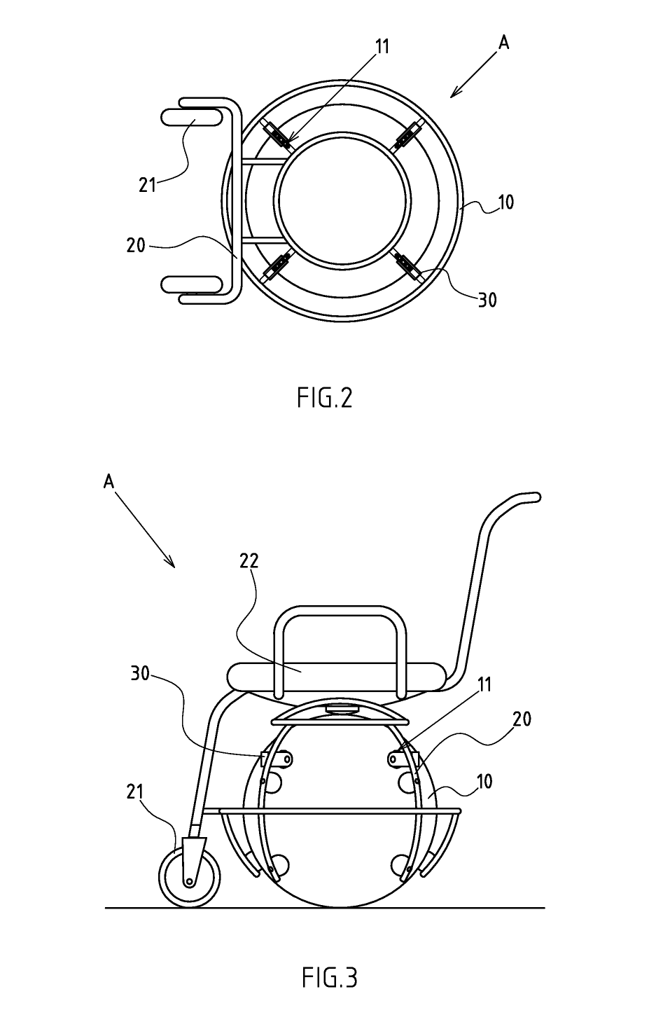

FIGS. 2 and 3 depict a schematic view wherein the spheric wheel 10 and driving wheel 11 of the present invention are combined onto an electric wheelchair A. Said electric wheelchair A is composed of a frame 20, a front wheel set 21 and a seat 22, as well as a spheric wheel 10 and driving wheel 11. When the driving gear 30 drives the driving wheel 11, the spheric wheel 10 is driven by the driving wheel 11 to move the electric wheelchair A. Of which, a rear wheel set can also be set onto the electric wheelchair A, so that the electric wheelchair A could move more stably. Further, the front wheel set 21 can be set for 360° rotation (referring to FIG. 3), so that the electric wheelchair A could move towards different directions by taking the front wheel set 21 as the pivoting point. A slip rotation state could be formed between the spheric wheel 10 and seat 22, so that the seat 22 of the electric wheelchair A could be rotated by taking the spheric wheel 10 as its pivot.

Moreover, a joystick is installed on the electric wheelchair A (not shown in the figures). Said joystick is provided with direction buttons and also knobs, so as to control the movement and rotation of the electric wheelchair A.

Based on the above-specified structural design, the present invention is operated as follows:

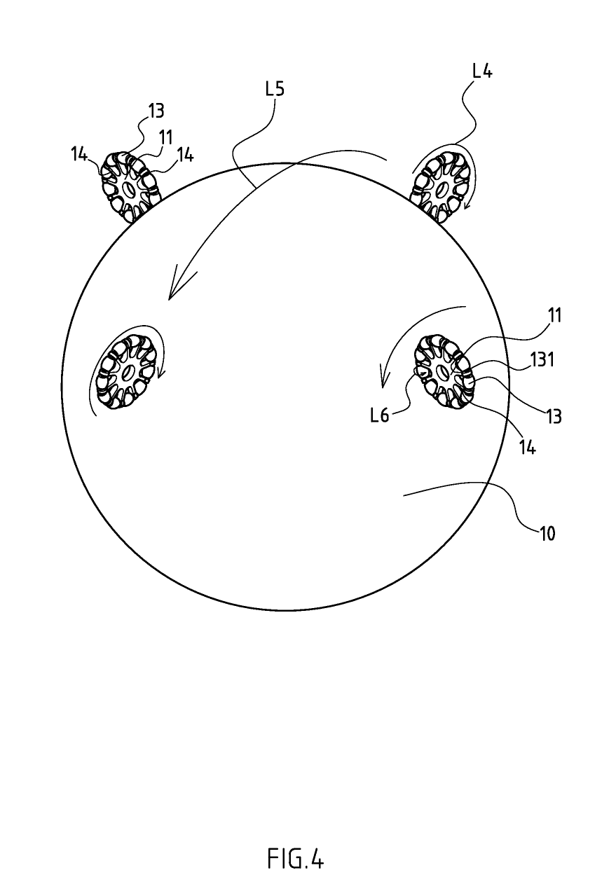

Referring to FIGS. 4, 5 and 6, when the driving gear 30 (referring to FIG. 7) drives the rotation of the driving wheels 11 (indicated by arrow L4), the spheric wheel 10 could be driven by the driving wheels 11 (indicated by arrow L5), while the driving wheels 11 set into different axial directions could drive frictionally the rolling elements 13 via the spheric wheel 10 (indicated by arrow L6), so that driving wheels 11 assembled at opposite directions could be abutted normally onto the surface of the spheric wheel 10 for driving or sliding without mutual interference. As compared with prior art, the driving wheel 11 of the present invention could be operated more smoothly without additional driving controller and clutch gear, so it features simple construction, stronger stability, lower manufacturing cost and floor area.

1. A multi-directional driving mechanism of a spheric wheel, wherein said multi-directional driving mechanism is assembled at a preset position on the surface of an existing spheric wheel, thus driving multi-directional rotation of the spheric wheel; the multi-directional driving mechanism comprises at least two driving wheels assembled at opposite directions of the spheric wheel; an axle is set at center of said driving wheel for driving the rotation via a driving gear; one lateral side of the driving wheel is abutted tightly onto the surface of the spheric wheel for frictional driving; it is characterized by that:
rolling elements are pivoted at interval on the periphery of the driving wheel; and the axial direction of said rolling elements runs perpendicular to the axial direction of axle on the driving wheel;
when the driving wheel is rotated by taking the axle as its pivot, the spheric wheel could be driven frictionally; when the axial directions of the driving wheel and spheric wheel are different from each other, the rolling elements on the periphery of the driving wheel will be frictionally pushed to rotate by the surface of the spheric wheel, so that the driving wheels assembled at opposite directions could be abutted normally onto the surface of the spheric wheel for driving or sliding without mutual interference.

2. The structure defined in claim 1, wherein yokes are set at interval onto the periphery of the driving wheel in a radial pattern; axle holes are set at external ends of said yokes; said rolling elements are of a column body with convex surface; and convex shafts are set at two opposite ends of the rolling elements for assembly into the axle holes set at external ends of the yokes.

3. The structure defined in claim 1, wherein the driving gear for driving the rotation of the driving wheel comprises of a [symbol] -shaped frame, a driving motor and changing gear sets; said [symbol] -shaped frame comprises of a main frame and two side frames set laterally at interval onto the main frame; a holding space is defined between two side frames to accommodate the driving wheel;
the driving motor is accommodated into the main frame, while the changing gear sets are separately set into two side frames, so as to link the driving motor and the axle of the driving wheel.

4. The structure defined in claim 1, wherein the spheric wheel is of a hollow round ball, which is assembled securely by several arched shell plates; a criss-cross skeleton is combined internally to support the arched shell plates.
